(19) United States
(12) Patent Application Publication
(10) Pub. No.: US 2009/0032448 A1
(43) Pub. Date: Feb. 5, 2009

(54) Solid Separating Apparatus, Compact Assembly, And Separating Method

(76) Inventor: Frank R. Kolb, Elz-Malmeneich (DE)

Correspondence Address: CHRIS PAPAGEORGE, 14625 S. VERMONT, # 5, GARDENA, CA, 90247, US

(21) Appl. No.: 11/814,678

(22) PCT Filed: Jan. 27, 2006
(86) PCT No.: PCT/EP2006/000709

§ 371 Date: Jun. 27, 2008

(30) Foreign Application Priority Data
Jan. 28, 2005 (DE) 10 2005 004 230.9

(51) Int. Cl. B01D 35/14; B01D 21/24; B01D 21/30; B01D 35/22; B01D 35/15

(52) U.S. Cl. 210/87; 210/137; 210/98; 210/106; 977/773

(57) ABSTRACT

The invention relates to an apparatus for separating solids from a liquid, comprising at least one reservoir or basin (12) for receiving solid-loaded liquid and having at least one inflow (1, 27, 101) and/or outflow (2, 111); and at least one separation device (9, 16, 25, 55, 56, 62, 63, 108) arranged in the reservoir or basin (12) for the solids, wherein the separation device has at least one separation surface, which is at least adjustable between a separation position (β) and a cleaning position (α). According to the invention, the apparatus comprises a control device (57, 58; 64, 66; 106) coupled or connected to the separation device (9, 16, 25, 55, 56, 62, 63, 108) and being operable by the liquid supplied into the reservoir or the basin (12), by means of which the position of the at least one separation surface can be changed or varied. Further a separation device (9) having at least one separation surface is provided, which comprises a surface coating and/or an at least partially structured surface. An arrangement includes such an arrangement or device in combination with at least one further solid separation device.

The invention relates to an apparatus, a device, a compact unit and a separation assembly, respectively, as well as a method for separating solids from a liquid, in particular in the field of drinking or wastewater treatment.

The separation of coarse and suspended substances is an essential object in the field of environmental protection techniques, in particular in the drinking water treatment, in the process water or rain water treatment as well as in the wastewater discharge and wastewater treatment. The separation degree and the selectivity are substantially influenced by the specific surface feeding, wherein this is proportional to the separation grain size, e.g. of mineral, metallic or organic particles. For the separation of small separation grain sizes, reservoirs having very large surfaces have to be implemented without additional installed equipment. From the field of mining technical methods emerged which enabled an increase of the effective separation surface with small reservoir surfaces. The effective separation surface has been mainly enlarged by installing surfaces arranged parallel to each other, so-called lamellae comprising an inclined position (blade angle) in respect of the perpendicular. The liquid loaded with particulate pollutants circulates within the reservoir or basin over the lamella surface, where the particles are separated.

Due to the inclined position of the lamellae and the different physical-chemical characteristics (density, structure, surface load etc.) of the particles, in particular their lipophilic or hydrophilic characteristics, sedimentations on the lamellae are possible. The removal is carried out by relocating the lamellae between the separation position and a cleaning position. The angle in respect of the perpendicular is dependent on the desired separation grain size in the separation position. In the cleaning position the lamellae are approximately perpendicular so that due to gravity the sedimentations can slip off and thus the lamella surface is cleaned off.

The cleaning of the lamellae is, however, not only determined by their orientation, but also by the time period during which the cleaning off is carried out, i.e. the cleaning cycle. The switching between separation and cleaning positions is enabled in U.S. Pat. No. 4,514,303 by means of a motor-operated winch, wherein the cleaning cycle itself is manually controlled. This control has the essential disadvantage that always a visual control of the lamellae is necessary. In particular in covered basins this control results in with an increased effort in costs, personnel and accident prevention.

In document DE 697 01 121 T2 the change between separation position and cleaning position is carried out float-controlled (either by additional floats or by lamella material having a lower density than water), wherein the lamellae take the separation position during the filling procedure of the basin. The cleaning cycle is determined by the filling and emptying cycles of the basin. A change between the fill levels in the basins is a required precondition for a correct operation in this alternative. By means of this coupling between the fill level in the basin and the position of the lamellae this control alternative has two significant disadvantages, which are conditional on the normal emptying times in particular in the field of the wastewater discharge on the one hand and on continuously dammed-up basins on the other hand.

In the field of process and rain water treatment as well as in the field of wastewater discharge, the change between the filling phase and the start of the emptying of the reservoirs lasts in a lot of cases more than six hours. This damming-up time results in most cases from the size of the reservoir volume, the production processes, the size of the dewatering area and the load of the wastewater treatment plant. What has not been considered in the known devices is that the solid load, however, is fed to the basins and reservoirs, respectively, within the first 30 to 60 minutes, so that the lamellae should take the cleaning position during this time.

In the float-controlled alternative the sedimentations, here in particular the lipophilic substances, have enough time to accumulate at the surface of the lamellae and to form gel-like agglomerates. Also in the cleaning position these agglomerates can not be removed only by gravity and form, with increasing dam-up events, thicker and thicker films. In continuously dammed up basins, such as in the drinking water treatment, rain clarifiers, sand traps, primary and final sedimentation basins of wastewater treatment plants as well as activated sludge reservoirs, this control alternative can not be used at all, as the lamellae never take up their cleaning position with the basin completely filled up.

It is an object of the invention to provide an apparatus, a device, an arrangement and a method for separating solids from a liquid, in which a cleaning of a separation device is carried out in a cost-saving and cost-efficient manner. Further, it is an object to expand the cleaning and treatment effect of a separation device.

This object is achieved by the features of claims 1, 11, 20 and 23, respectively.

Advantageous embodiments are subject matter of the dependent claims.

To achieve this object a control value has been found, which enables a statement of the flow and solid conditions in the cleaning basin, and which is independent of the fill level. Within the environmental protection technique, in particular the rain water treatment and/or the wastewater discharge and/or the wastewater treatment, the use of flow and flow velocity, respectively, results in a cost-saving and efficient control of a separation device (e.g. separation lamellae) between its separation position and its cleaning position under all operation conditions in a basin.

For this a method, a device and a separation arrangement are proposed, in which the flow of the inflowing or outflowing liquid or the flow velocity are detected for example in the inflow or outflow region of the basin or reservoir or within the basin or reservoir. Generally the solid load of the liquid is directly proportional to the flow velocity, as both, load and velocity, are coupled to each other by the friction force. If the flow velocity is detected and transformed into a pressure and/or a force, the separation device or parts of the separation device can be positioned by this force so that its projected surface is adapted for the respective liquid supply or solid supply for the solid separating.

According to claim 1 the position of the separation device is advantageously influenced by means of a control unit so that the surface that is crossed by the flow is enlarged with starting or increasing flow, so that in the solid separation the effective surface and the surface effect, respectively, is increased.

If for the separation of solids the separation device comprises adjustably arranged separation areas, so-called lamellae, its adjustment is sufficient for the adjusted solid separation.

In an embodiment the flow velocity is detected by a control device comprising, for example, a housing and a flow body (referred to as ‘body’ in the following). In the control device the flow velocity is transformed into a dynamic pressure exerting a force to the surface of the body. This force results in a movement of the moveably arranged body in the control device, which in turn can be used for a position change or a change of the orientation of the separation surfaces. The movement can be transferred to the separation surfaces (lamellae) for example via a mechanic connection and thus change their position or blade angle.

The retraction force for the flow body can be generated, for example, by the weight of the lamellae or separation surfaces. Advantageously the lamellae or the lamella package comprise a higher medium density than the ambient liquid (e.g. water in the rain water treatment, wastewater drain or wastewater treatment), so that the downward impetus results in the retraction of the flow body. Alternatively or additionally a retraction force results from the buoyancy of the flow body itself if the medium density of the flow body is lower than the ambient liquid. Supportingly or alternatively the retraction is effected via a spring-operated retraction device (e.g. via a spring tension) or via a gravity-operated retraction device (e.g. weight of a weight element acts on the flow body or the lamellae opposite to the flow force).

As the movement change of the flow body is also proportional to the flow velocity, the blade angle becomes greater with a higher flow velocity and a solid load, so that the horizontally projected surface enlarges and more solids can be separated.

In the rain water treatment and the wastewater discharge the flow velocity decreases after the damming-up of the basin or the reservoir, and the flow body returns to its starting position, so that the lamellae resume their cleaning position. Independent of the damming length and the fill level, in this method the cleaning position is resumed again and again, so that the time periods are far too short to enable a non-removable sedimentation on the lamellae.

In the wastewater treatment the flow velocity follows the daily hydrograph of the wastewater, so that in these basins or reservoirs the cleaning position is resumed also at low inflow volumes and a cleaning off of the lamellae results.

Another embodiment comprises a control device having a perforated flow body. Thereby solids from the liquid can deposit during the flow-through process at the through holes and above and/or within the through holes, respectively, and thus increase the pressure drop by the body during the flow-through in dependency of the solid load. The increase of the flow pressure drop of the body results, in turn, in a movement of the same, which is used to change the position for the lamellae.

In a further embodiment the solid-loaded liquid flows within a channel along a connection element, for example along a tube. This element is connected to one side of a pressure unit comprising at least two pressure chambers separated by a membrane. The second pressure chamber is for example exposed to the ambient pressure. The two pressure chambers act as a differential pressure manometer, in which the membrane is flatly aligned in the zero position. Compared to the ambient pressure a lower pressure is generated by the flowing liquid, so that the biased membrane deflects from its central position. The change of the central position of the membrane can be used for controlling the lamellae.

The control devices mentioned above can only enable an indirect non-quantitative detection of the solids, whereas in an embodiment of the method, sensors are used, which allows indirect quantitative information in respect of the present solids in the liquid. With corresponding characteristics of the solids the mechanical sensor can determine in the control device, for example, the accumulated mass of the solids (sedimentation balance), the electrical sensor can determine the conductivity, the optical sensor can determine the opacity, and the hydraulic sensor can determine the viscosity. The measured values are transformed e.g. in a proportional signal. This signal can be transferred by the control device to an actuator and can carry out the activation of the corresponding lamella position in a mechanical, electrical, pneumatic or hydraulic way. If the solids content in the reservoir liquid or the position of the lamellae is detected by an additional sensor, the control circuit can be expanded to a feedback-loop circuit.

A cost-saving embodiment of the control device is the position change of the lamellae in time-discrete steps. A time switch can for example be used as a control device, which activates an actuator, diverting the lamellae for example in a half-hourly rhythm from their separation position into their cleaning position and which switches back into the separation position after, for example, five minutes of cleaning.

To enable a preferably easy and cost-saving construction of the entire separation device, the connection element between control device and deflection device or diverting device is formed in an embodiment, for example, as a rope, a chain or a rod-like bar. These connection elements can only transfer traction forces but no pressure forces. For this reason the connection elements have to be dimensioned to only one force direction and can therefore be provided with low weight. This kind of connection elements advantageously result in little mass moments of inertia so that the control device has to bring up only minimal additional actuating forces to change the lamella position.

In the liquids to be treated, for example rain water, there are not only particulate substances but also solutes, such as heavy metals, nitrate, nitrite, chlorides, sulfates or organometallic compounds which can be adsorptively bonded via active media, such as charcoal, active coke, clinoptiolith or hydroxyl apatite. Therefore, a composite arrangement of the lamellae is proposed in an embodiment of the method. The composite arrangement of the lamellae can be formed so that the material, including the active layers for removing the solutes, is detachably or irremovably connected to the actual separation surfaces. The detachable connection has the advantage that the adsorbents can also be subsequently adapted to special contaminants in the liquid.

In an embodiment of the separation surface the same comprises a composite assembly. In an irremovable connection the composite assembly has the advantage that the lamellae have lower weight and can thus be mounted with less effort. This is particularly advantageous, if the separation device is installed in covered buildings, such as ducts or rain basins.

With an automatic cleaning of the lamellae by their position change the force disequilibrium between the adhesive force of the separated solids on the separation surfaces and the gravity effect on the separated solids is utilized as cleaning mechanism. For this reason the cleaning effect of gravity can be improved by minimizing the adhesive forces, depending on the solids and the characteristics of the lamella surface. In an embodiment the lamellae are coated with nanoparticles (lotus effect), effecting a change of the surface potentials. Thereby, for example lipophilic solutes can be transferred into particulate substances and separated at the lamella surfaces. For the lamellae synthetic materials can also be used, which have a special scale-like surface structure (shark effect). By means of this surface the boundary layer characteristics are particularly positively influenced so that the adhesive forces in aqueous ambient media are minimized and the solid sedimentations advantageously slip off more easily in the cleaning position.

In order for the separated solids not to be re-suspended, they have to be collected in the separation device and have to be discharged as promptly as possible. In rain basins in bypass and for reservoirs an additional discharge element has to be provided for the solids. In an embodiment of the method, robust conveying elements, such as a pump having a Hardex conveying wheel or a conveying screw, are employed for the solid input. Particularly advantageous is a conveying element that does not require moved parts for conveying, such as an airlift.

In basins or reservoirs in the discharge system in which a work-off is carried out, i.e. a change between filling and emptying, the separation device can be provided with a hydraulic device to remove the solids. The removal of the separated solids is carried out after emptying the basin or reservoir. To clean these basins, hydraulic devices, such as rinsing dumps, flap-provided or flap-free rinsing chambers as well as spray nozzle rails, which generate a cleaning flush, are particularly appropriate. In these methods the solid transport is advantageously carried out by the friction force of supplied hydro power so that no wear can be caused by mineral particles.

Advantageously the separated particles are collected below the separation surfaces and discharged out of the reservoir or basin by a conveying element (for example a pump), a conveying screw or an airlift. In another embodiment or additionally the separated particles are collected below the separation surfaces and are discharged out of the basin or reservoir after the work-off of the basin or reservoir by a cleaning device, such as a rinsing dump, a flapless flush cleaning or a spray nozzle rail.

The simplest and thus most cost-saving device for controlling the position of the separation surface or surfaces is that the control device is integrated into the separation surfaces. To achieve this, the separation surfaces are for example rotatably supported, and a partial flow or the entire supplied liquid and thus the supplied solids are flown against a portion of the surface. Due to this hitting flow, a force is exerted on this portion of the control device/separation surface combination, which results in a position change around the rotation axis. To intensify the effect of the hitting flow, a portion of the surface or the entire surface acting as control device can advantageously be bent up to an angle of 90° relative to the separation surface.

In an embodiment of the device it is advantageous to effect a movement or lifting of a flow body by the inflowing liquid, wherein the flow velocity is transformed into a force. In the field of fluid techniques the flow velocity can be transformed with little effort into a flow pressure by a flow body, which can be transformed into a movement when the body is movably arranged. In this transformation by the flow body it is advantageous that the body is formed so that preferably no or only little separation turbulences are generated, which would cause additional force loss. The pressure force of the flowing liquid can be increased by a housing in which the body is guided. In respect of the design of the housing attention has to be paid in that the dynamic pressure acts as even as possible on the body so that it is not exposed to additional moments (for example moments of torque or tilt).

A cost-saving embodiment of the control device is for example to use a tube as a housing for the body, which, when a flow is passing, has at the same time the essential advantage of a radial-symmetrical distribution of the pressure forces and the pressure losses, respectively. In this assembly the pressure forces do not result in a rotation of the body receiving the pressure forces. The body for receiving the pressure forces should as well be rotational-symmetrically designed so that there is also an even force distribution on it. In flow-technical view the body for receiving the pressure forces could have a drop-like or simplified a tapered form and be arranged in the flow so that the turbulence losses are minimized. For guiding the body the housing can have at least one guiding element, for example a groove or a U profile. The body for receiving the flow pressure also contains a guiding element, wherein it should advantageously be a corresponding counterpart to the guiding element of the housing, for example a pin or a rail which are fixedly connected to the body.

The combination of the two guiding elements represents a linear guiding for the body which can dodge the pressure forces acting on it in the direction of the linear guiding and can thus change its position.

In an embodiment the flow body comprises e.g. a horizontally supported surface having at least one gap relative to the housing, so that the solid-loaded liquid flows through the gap and the pressure difference emerging thereby results in a deflection of the surface.

To transfer the position change of the flow body to the at least one separation surface (lamellae) either its guiding elements or the body are connected to the lamellae directly or via a connection element (for example via a synthetic rope which in turn can be guided via a diverting device). Or, if a transformation (gear transmission ratio/gear reduction ratio) of the body's movement is necessary, the body and the at least one separation surface are coupled or connected via a deflection device which in turn is mounted at its other end to the lamellae by a further connection element.

For the detection of the solid load of the liquid by a mechanically acting body, through holes provided in it are appropriate, which can clog dependent on the solid load in order to thereby increase the pressure drop proportional to the load and thereby deflect. In an embodiment of the device the body is for example formed as a flat plate comprising for example slit-like or circle-like through holes having different diameters from 0.5 to 5 mm. During the flow-through the body by the liquid to be cleaned the free cross-sectional area more and more decreases so that the flow pressure becomes higher and higher and more and more displaces the body in its guiding. The body is also provided with a connection element for controlling the lamella position.

In an embodiment of the control device deposited solids are removed from the flow body by e.g. activating a cleaning device, for example by an actuating mechanism, which is provided for example on the upper and/or lower travel position of the body including for example opposite through holes or raised parts, by means of which the surface of the body is cleaned. As the solids clog the through holes of the body, they have to be removed again from the through holes at the end of the control cycle. For this purpose at least one cleaning device is provided which for example is arranged at the upper or lower end of the travel path or advantageously at both ends of the travel path. In case of the above described exemplary body the cleaning device can consist of a plate having rips on which studs are arranged which fit into the respective through holes of the body. If the body reaches the upper and/or lower end position of its travel path, the studs break through the through holes and thereby remove the solid deposits from the body.

In an embodiment the deflection device or diverting device transforms a decrease or an increase of the actual signals or values (flow velocity, liquid level, solid load, opacity—see above) of the control device in a mechanical, electrical, pneumatic or hydraulic way. For example, the mechanic deflection device or diverting device comprise an asymmetrically acting lever in which the control device is connected for an up-transformation to the smaller lever part and for a down-transformation to the greater lever part; Or it includes a cam disk having an alterable diameter; Or an electrical deflection device or diverting device include for example an actuator. A pneumatic as well as hydraulic deflection device or diverting device include for example a travel piston.

Advantageously the control element is arranged in such a way that at hydraulic dwell times of about 5 mins the control characteristic of the lamellae is advancing and in a hydraulic dwell time of far more than 5 mins the control characteristic of the lamellae is lagging.

Another cost-saving embodiment of the body for receiving the flow pressure forces consists of at least one unilaterally supported plate moveably supported in the housing of the control device. At least at one lateral surface of the plate, advantageously opposite to the support, there is at least one latch mounted to the lamellae via connection elements. Between plate and housing there is at least one gap through which the solid-loaded liquid can flow. Dependent on the inflowing volume flow the pressure force and thus the adjusting force for the plate varies. The deflection of the plate is carried out around the pivotal point of the support and the retraction is carried out via the weight of the lamellae.

Advantageously the control device, through which at least one partial flow of the solid-loaded liquid flows, comprises an advantageously cylindrical housing, for example a tube section, and at least one guiding element, such as a groove or a U-shaped channel, in which a moveable body having at least one guiding element is arranged and connected at least at one end of the body or of the guiding element of the body to at least one deflection device or diverting device and/or to the separation surfaces via a connection element.

To position the separation surfaces or lamellae within the separation device a force has to be exerted which is generated by the dynamic pressure acting on the body in the control device. This force can act, as described above, either directly or indirectly on the separation surfaces. In respect of the indirect effect, constructive components such as connection elements or diverting and/or deflection devices or a combination of diverting and deflection device is required for the transmission of the force from the control device to the lamellae.

To minimize the inertia of the movement transmission between control device and lamellae, the connection elements should have a weight as low as possible. To enable this, as described in an embodiment, the force distribution between control device and lamellae should be selected so that in the connection elements mainly traction forces occur only, as almost all materials can transfer high traction forces in small workpiece dimensions, so that for example a rope can be used as connection element.

The essential function of the diverting device is that the force flow in the connection elements has to be guided so that in those mainly traction forces occur only. The diverting device or diverting devices can for example be composed of rolls in which the connection element is guided and the force always acts in axial direction of the connection element only.

The deflection device comprises in addition to the diverting device the function to change the movement between the control device and the lamellae. Thereby, with low liquid supply at high solid load, the movement is advantageously enlarged by the deflection device to thereby adapt the horizontally projected separation surface to the high solid ratios, and, with high liquid supply at low solid load, the movement is diminished to minimize the turbulences by the lamella positioning. A cost-saving solution for a deflection element is an asymmetrically acting lever, wherein the asymmetry can be implemented for example by an excentric support or by lever partial sections having different lengths.

A combination of diverting and deflection device can be implemented for example by a cam disk, the diameter of which is continuously increasing in movement direction in order to enlarge the movement, or the diameter of which continuously decreases in the movement direction in order to diminish the movement.

As an embodiment, in addition to a pure mechanical control, diverting and/or deflection device, also combinations of for example optical or electrical control devices as well as electrical, pneumatic or hydraulic diverting devices or deflection devices can be used. The optical control device can for example consist of an opacity sensor, the signal of which in turn is transformed into an electrical control value, by means of which an actuator is controlled, such as a stepping motor connected to the separation surfaces by a connection element. The actuator can be arranged so that it acts as diverting element and simultaneously by a transformation of the signal from the opacity sensor into the electrical control value and/or from the electrical control value to the stepping motor, performing the function of the deflection device.

According to a particularly advantageous embodiment or in the separation device according to claim 11, the surface of the separation surface or the separation device is at least partially coated with a functional layer. In this embodiment it is not required that the separation device or the separation surface is moved, these can also be stationary or moveable by a different device than the control device. The functional layer is a structured layer, an anti-adhesive layer, a biologically effective layer and/or a chemically effective layer. Or advantageously at least one layer comprising a combination of one or more of these functions. In an embodiment the surface of the lamellae is at least partially coated with nanoparticles or the material for the lamellae is selected for example including or of polytetrafluorethylene, so that the adhesive forces between the substances in the liquid to be cleaned and the lamellae is minimized.

Thereby the cleaning of the lamella surface is supported by gravity or the sedimentations can automatically slip off.

In a further alternative or additional embodiment the surface of the at least one separation surface (e.g. lamellae or material for the lamellae) is coated with a biocide effective substance, for example silver ions, or is doped to avoid and minimize microbial fouling on the surface of the lamellae.

The structured surface for example is a coating with particles in nanosize, wherein the particles include biologically and/or chemically active particle elements or are formed of those. By means of the so-called nanoparticles the surface characteristic (e.g. lotus effect) is influenced. By means of this effect the adhesive forces between the surfaces and sedimentations are substantially altered and also the flow along the surface is modified, e.g. the slip off of fluid layers. Both effects can be used in an embodiment of the device for the improved cleaning of the separation surfaces. By means of the alteration of the surface potentials the adhesive forces between the sedimentations and the separation surface are minimized, and by means of the influence of the border layer forces a slip off of the sedimentations in the cleaning position is benefited. For improving the slip off in the cleaning position the surface structure can be formed scale-like.

The separation of solids from a liquid is considerably influenced by the suspension characteristics. From a particle diameter of 150 μm a suspension can be seen as being stable so that solely by means of flat surfaces no separation can be achieved anymore. These suspensions having high silt fractions and in connection thereto with particle sizes smaller than 150 μm exist however just in the field of the rain water seepage. That's why in another embodiment of the method the composite arrangement of the separation surfaces is set forth, wherein the composite arrangement of the separation surfaces can be carried out separable or inseparable. For an efficient separation of solutes at least one separation surface of one composite material is used, which is mounted at least at one side, preferably on the lower side in relation to the horizontal, and at least one support layer which is capable due to its physical-chemical characteristics to receive particulate micro fractions and/or solutes from the liquid.

The advantage of the separable assembly is the subsequent adaptation of the separation surfaces to changed solid compositions in the liquid. The advantage of inseparable solutions is the assembling-friendly installation of these separation surfaces in particular at covered buildings. The at least two partial surfaces of the composite assembly differ in particular in their surface structures. The upper separation surface in vertical direction has a smooth structure to separate all particles instably located in the suspension. The further separation surface has a structured surface, such as geotextiles, to be able to separate particles stably located in the suspension.

The separation process for the stable suspension is explained in more detail on the basis of geotextiles. The geotextiles consist of different fibers, for example polypropylene, which are interwoven, needled or felted with each other. Thus a surface of geotextiles has a great specific surface, and by means of the particular manufacturing method the material has a high stopping effect as in a filter with small pressure losses. In the real separation process this surface is hit or flown through by the flow of the stable suspension wherein at the fibers of the geotextile separation surfaces the particles are separated from the liquid by means of adhesive forces and/or by means of the stopping effect of the fabric.

By means of a composite assembly of the separation surfaces only particulate substances can be mainly separated from the liquid. In a lot of liquids to be treated, however, there are also solutes, such as heavy metals, nitrate, nitrite, chloride, sulfate, organic compounds as well as metal-organic compounds etc. in the rain water. To remove these substances the separation surface has to comprise at least one active layer, for example a geotextile, plastic or foam plastic layer. These layers in turn can be removably or inseparably connected to each other. The activation of the further separation surface can for example be carried out for the removal of organic compounds form the liquid by activated carbon or activated coke. The different ion groups can be removed from the liquid by natural or synthetic ion exchanger materials. The including of the activating materials into the active layer can be carried out by coating the fibers, by fusing or by filling the porous basic material with these active substances. If only solved particles should be mainly removed, the separation surfaces can be installed in a fixed angle, wherein this angle should approximately correspond to the angle of rest of the sedimentations.

By means of the arrangement of the flow body, for example in the inflow or outflow of the basins or reservoirs the control strategy can be influenced. In the arrangement at the inflow, an advancing control characteristic is achieved, and in the arrangement at the outflow, a lagging characteristic is achieved. The advancing control characteristic should be used at small storage volume and high volume flows so that for the solid separation directly at the beginning of the filling phase or the daily hydrograph peak the greatest separation surface possible is available. In great storage volumes and small volume flows the lagging control characteristic should be used to achieve a pre-treatment by the sedimentation process during the filling phase or during the flow-through the separation device, and thus to lower the specific surface load of the lamellae, or—at unchanged surface load—to achieve the same solid value in the outflow by means of a smaller number of lamellae.

In an embodiment of the method or the device the control device comprises a perforated flow-through body, the through holes of which are partially or completely clogged up by the solids during the flow-through of the solid-loaded liquid. This enhances the build up of a pressure difference resulting in a movement of the flow-through body, which in turn is used for a change of the position of the separation surfaces.

In a further embodiment the control device comprises a channel in which the solid-loaded liquid passes by an opening of the connection element, wherein the connection may be a tube ending up at one side of a pressure unit having at least two pressure chambers and the pressure chambers of which are separated by an elastic membrane, wherein the second pressure chamber is connected for example to the ambient pressure, so that depending on the flow velocity in the channel a pressure difference is generated in the pressure unit and thereby a deflection of the membrane is caused, which is used for changing the position of the separation surfaces.

Particularly advantageously or additionally the flow velocity and/or the solids content of the liquid is detected by a mechanical, electrical, optical, pneumatic or hydraulic sensor, and the flow energy is transformed into a movement change in a mechanical, electrical, pneumatic or hydraulic way, which is used for a position change of the separation surfaces.

Advantageously the separation surfaces can be moved between their at least two positions in time-discrete steps, for example change with a dwell time of 30 minutes in the separation position and 5 minutes in the cleaning position.

A connection element between the control device and the separation device is for example a chain, a rope or rods as well as a deflection device or a diverting device which for example consists of an asymmetrically acting lever, which enlarges the change of the control device and transforms the change to the separation surfaces of the separation device for the position change.

For the use of the separation device in the wastewater treatment, in addition to the particulate mineral solids, there are also contained lightweight substances, such as fats and oils, as well as fibrous, mostly organic solids in the liquid. To remove these substances from the liquid it is advantageous to combine the separation device according to claim 20 in a separation arrangement with at least one mechanic pre-cleaning stage, such as a rake, and/or at least a further stage for the separation of emulsified and/or coagulated lipophilic substances. By means of the mechanic pre-cleaning stage the fibrous and/or lumpy, mostly organic solids can be removed from the liquid depending on the size of their through holes. The stage for the separation of the lipids and lipoid substances may for example be constructed as a grease trap, in which air is for example blown into in order to decrease the medium density and to alter the surface tension of the liquid so that these substances float onto the liquid surface and can be removed. The arrangement of the at least three stages is arbitrary and depends on the ratio of the different solid fractions of the liquid to be treated. In the wastewater cleaning the stages could be employed due to the general wastewater composition for example in the order: mechanic pre-cleaning, grease trap and separation device.

Advantageously the separation device is used with at least one stage for the separation of solved and/or unsolved lipids or lipoid substances the separation performance of which is for example increased by diminishing the medium density of the liquid, for example by the inflow of air via a ventilation rail, and/or is combined with at least one stage for the separation of coarse substances which mainly separates particulate substances having a greater equivalent diameter than the separation device, for example by a rake, wherein the individual stage can be arranged before or after the separation device.

In a further embodiment the separation device is combined with at least one stage for separating or retaining solved molecules and/or suspended micro organisms or micro organism agglomerates, wherein the separating or the retaining can be carried out for example by membranes.

In wastewater cleaning the so-called sludge activation method for cleaning the liquid is very frequently used. The sludge activation method is characterized in that suspended micro organisms in a reservoir or basin come into contact with solved and/or particulate liquid substances and transform them in biochemical way. To permanently maintain this process the micro organisms have to be separated again from the liquid at the end of the cleaning process. This separation is very cost-intensive, as it is carried out in special high-volume basins, so-called final sedimentation basins. By employing the separation device these basins can be made smaller and thus the entire process can be carried out more cost-efficient.

For a combination of the separation device with a membrane method, as set forth in an embodiment, the liquid can yet be cleaned up to the molecular range of contaminants and micro organisms. The cleaning effect and the throughput can be determined by the pore areas of the membranes. The arrangement of both stages (separation device and membranes) is arbitrary, wherein preferably the solids should be removed by the separation device in the macroscopic range and then through the membrane in the microscopic range.

The invention is explained on the basis of the following drawings, which show:

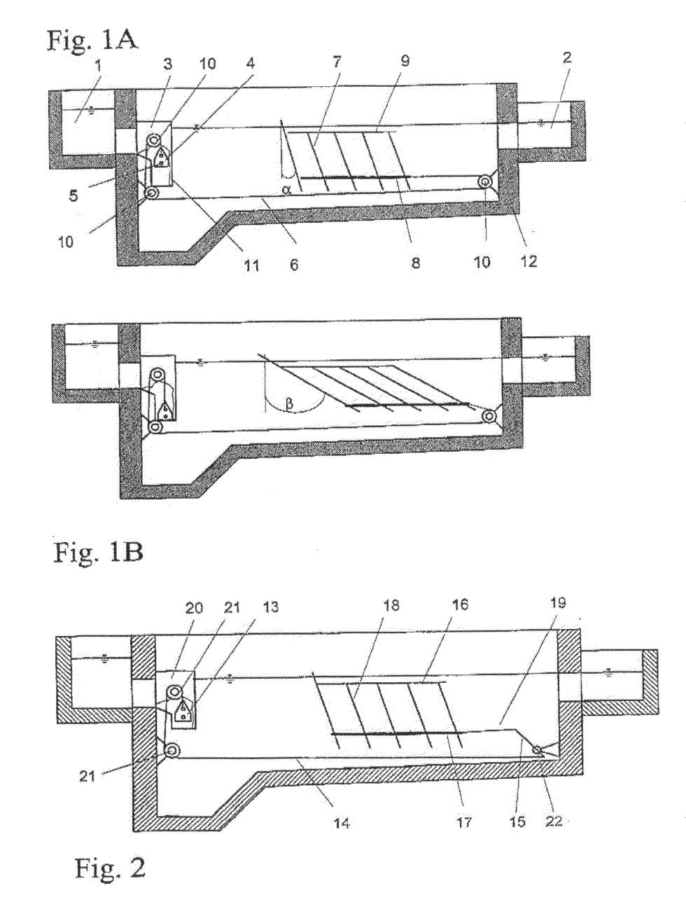

FIGS. 1A and 1B a separation device having a control device, a connection element and a diverting device for controlling the cleaning position (FIG. 1A) and separation position (FIG. 1B) of separation surfaces,

FIG. 2 a schematic diagram of a modification of the device of FIG. 1A having an asymmetrically supported lever as deflection device,

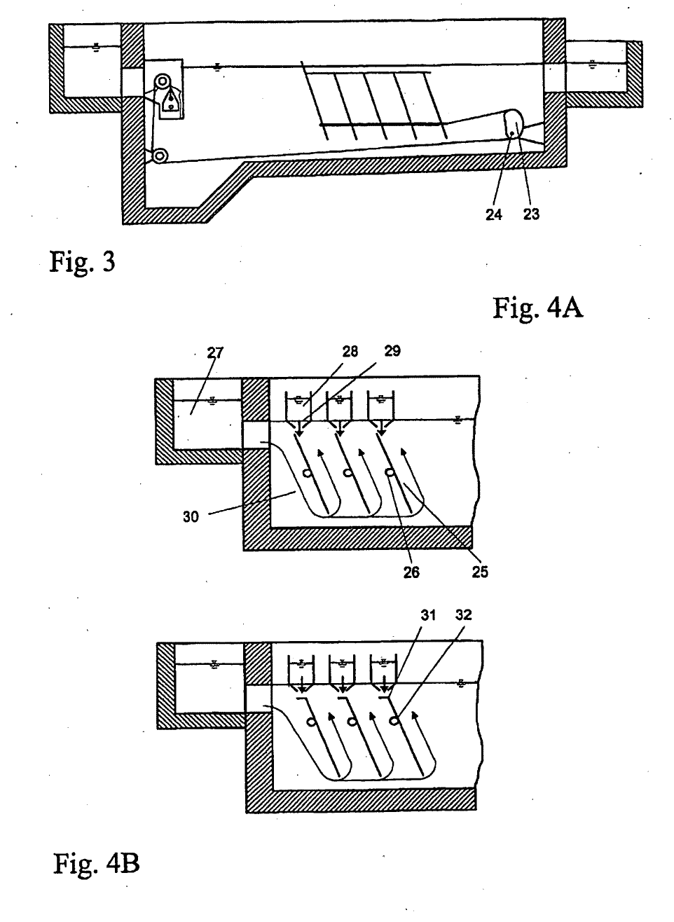

FIG. 3 a schematic diagram of a modification of the device of FIG. 1A having a cam disk as combined diverting and deflection device,

FIGS. 4a and 4B schematic diagrams of a first and second alternative of a further combined control/separation device having two different constructive embodiments,

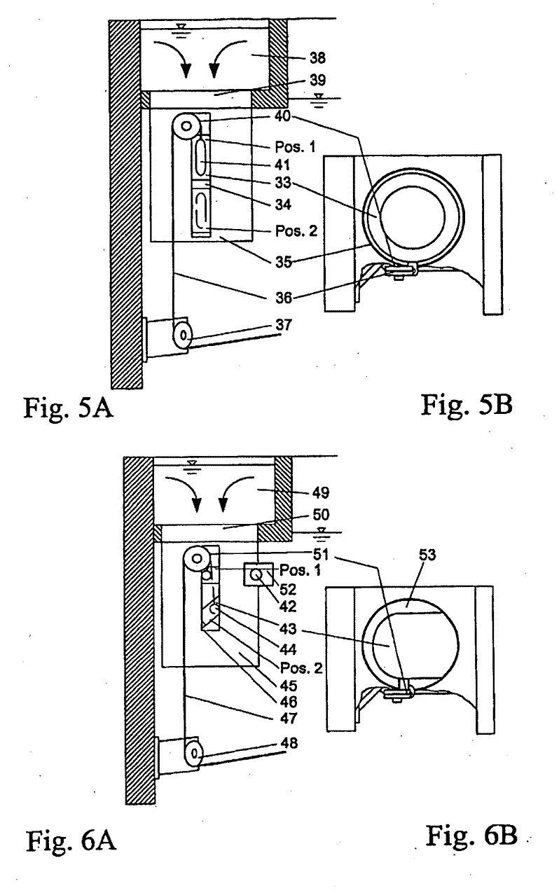

FIGS. 5A and 5B a side view and a top view of a control device having a ring-shaped flow body for transforming the flow pressure into a lamella arrangement,

FIGS. 6A and 6B a side view and a top view of a further embodiment of a control device including a unilaterally supported plate as flow body for generating the flow pressure,

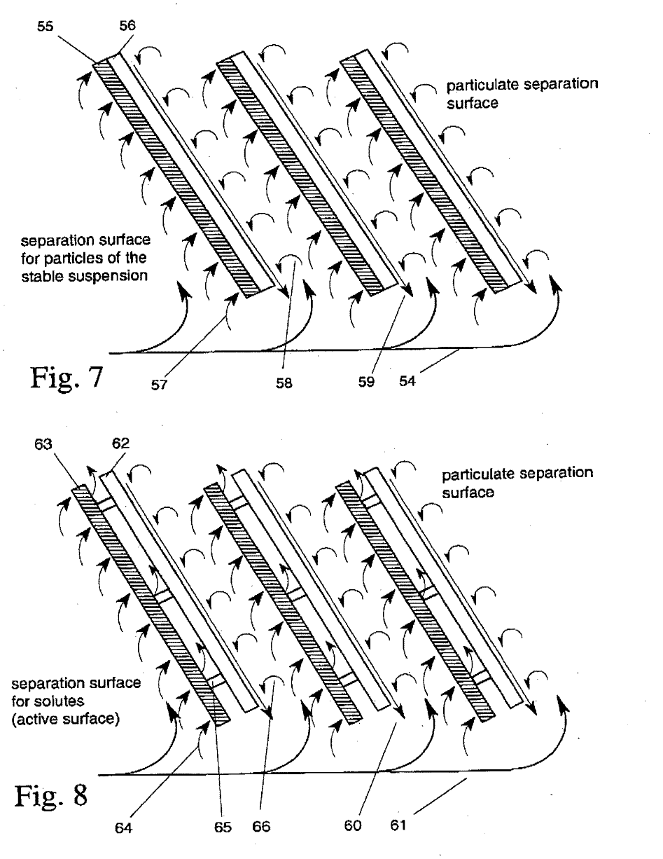

FIG. 7 a schematic diagram of a composite design of the separation surfaces in an inseparable embodiment,

FIG. 8 a schematic diagram of a composite design of the separation surfaces in a separable embodiment,

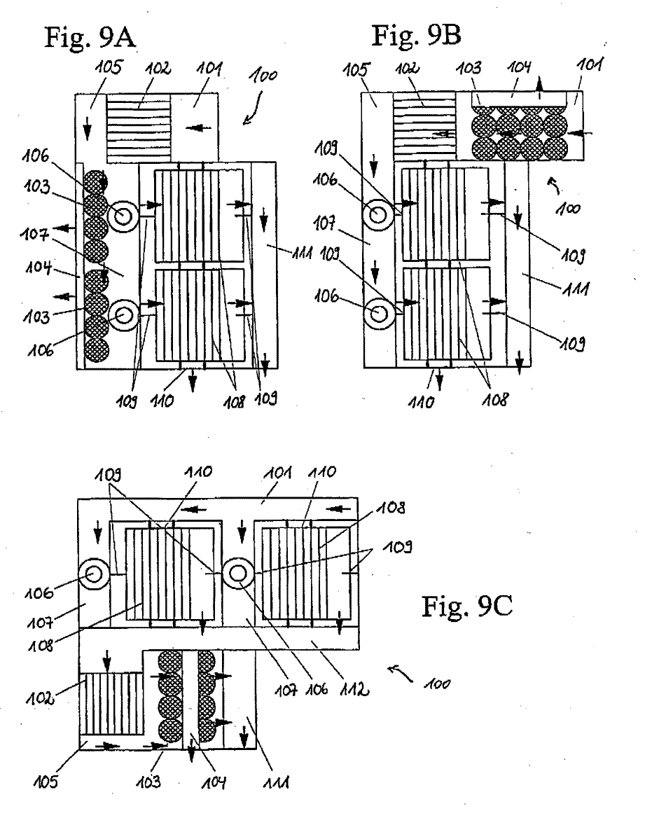

FIG. 9A to 9C different compact modules having a separation device in combination with a coarse substance and grease separator, and

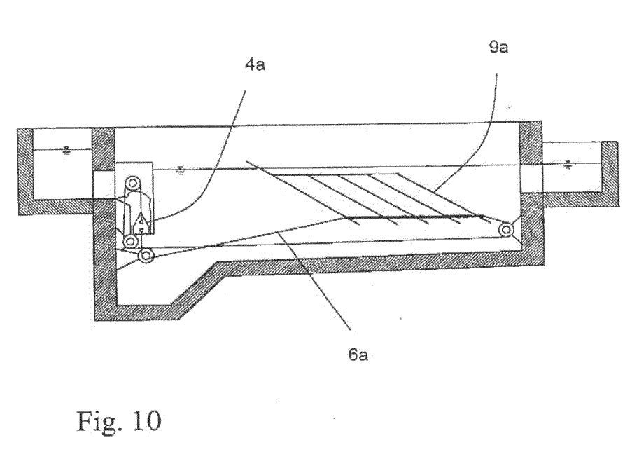

FIG. 10 a further embodiment of the separation device as shown in FIGS. 1A and 1B having a flow body formed as float.

FIGS. 1A and 1B show the method and device principle of a separation device 9 located in a basin 12. The control or adjustment of the separation surface position or alignment of the separation surfaces 7 of the separation device 9 is carried out by a control device 11 having a housing 3 in which a flow body 4 including its guiding elements 5 is arranged. In an inflow 1 to the basin 12 the supplied solid-loaded liquid is directed through the inflow opening into the control device 11 and a dynamic pressure is generated by the flow body 4. To dodge this pressure the flow body 4 changes its position within the control device 11. This movement of the flow body is passed on to a connection element 6 via guiding elements 10. By the movement of the flow body the connection element 6 undergoes a traction force being diverted to the separation surfaces 7 by the diverting elements 10. Based on the orientation shown in FIG. 1A (cleaning position), with increasing flow or increasing flow pressure the angle α of the separation surfaces 7 (lamellae) in position 1 is increased so that in the orientation shown in FIG. 1B (separation position) the lamellae 7 takes the angle β relative to the perpendicular.

In an embodiment the angle α can be smaller or even negative, for example be in the range of ±10°, preferably ±5°, around the vertical. In a maximum deflection the angle β is preferably within the range of 30° to 90° to the vertical, advantageously in the range of 40° to 60°. In an embodiment the hub or the rotation angle of the separation device 9 in the cleaning position and/or in the separation position are limited by a stopper. The control device can be adjusted so that the separation device pivots back and forth nearly binary between the cleaning position and the separation position, as soon as a threshold value of the flow-through velocity of the inflowing liquid is exceeded. Or the position of the lamellae 7 changes continuously or steadily depending on the flow-through velocity. Correspondingly, these embodiments are offhand applicable also in the separation devices described below.

In the separation device 9 the lamellae are rotatably supported at their upper end and connected to each other by a holding bar 8 at their lower end. After the solid-loaded liquid is cleaned after flowing through the separation device, it leaves the basin via an outflow channel 2.

FIG. 10 shows a separation device 9a in an embodiment of the separation device 9 shown in FIGS. 1A and 1B. Instead of the flow body 4, here, a flow body 4a is used which is formed as float, i.e. which undergoes buoyance in water. In addition to the flow-operated deflection of the separation device 9a the flow body 4a thereby—with decreasing flow—has at least a supporting function for the retraction of the separation device 9a and the separation surfaces 7, respectively. The retraction force during buoyancy of the flow body 4a is transferred by a second connection element 6a (rope running over diverting elements), the one end of which is connected to the flow body and the other end of which is connected to the separation device 9a. In other respects the other shown elements correspond to the elements shown in FIGS. 1A and 1B.

As described above, the individual lamellae 18 are connected to a connection element 8 (here bar) so that it is sufficient, if the second connection element is connected to one of the lamellae or to the connection element. By means of the liquid pressure the flow body 9a dodges and transfers its position or deflection via the first connection element 6 to the lamellae 18. If the liquid pressure decreases, a buoyancy force is generated by the low medium density of the flow body 9a as compared to the surrounding liquid, which causes a retraction of the lamellae via the second connection element 6a.

A similar embodiment shows FIG. 2, wherein the diverting device of FIG. 1A is replaced by a deflection device 15 comprising an excentric bearing 22 and in which a second connection element 19 is used, which is connected to the lamellae 18 by the holding bar 17 (compare holding bar 8). By means of the different partial levers of the deflection device 15 a small change of the movement of the flow body 13 (compare flow body 4) is transformed in a significantly greater position change or alignment change of the lamellae.

FIG. 3 shows another embodiment of the separation device in the cleaning position, in which a combination of a diverting and deflection device in form of a cam disk 23 having a bearing 24 is provided. The bearing 24 is arranged at the cam disk 23 so that the deflection of the flow body 4 is continuously transformed by the increasing transformation in an increasing deflection of the lamellae until the lamellae have reached their maximum separation position (compare FIG. 1B).

In FIGS. 4A and 4B two alternatives of a combined control device/separation device are shown, wherein the main part of the solid-loaded liquid is supplied to the basin and the separation device via an inflow channel 27. The separation device in the alternative of FIG. 4A includes individual control device/separation surface segments 25 wherein to their upper partial surfaces the solid-loaded liquid 29 is flown via distribution channels 28. Thereby a flow pressure is formed on the upper surface portions of the segments 25. Thus each of the segments 25 also acts as a control device for changing the alignment of the angular position of the segments depending on the liquid flowing in via the distribution channel 28. The flow pressure causes a position change of the segments, as they are supported rotatably or pivotably by means of a pivot bearing 26. The main part of the solid-loaded liquid distributes during the flow-through of the segments 25 approximately the way as it is shown by the flow path 30. The retraction of the segments is carried out gravity-operated by the weight of the partial separation surfaces below the pivotal point, which have a higher weight as the partial surfaces arranged above.

In the alternative shown in FIG. 4B the angled surface section 31 is used as a control device. The flow towards it is carried out as in the alternative of FIG. 4A, but the partial separation surfaces arranged below the pivotal point 32 can be enlarged, since the torque generated by the flow pressure onto the control surfaces 31 is increased by the bending of the surface section 31 as compared to the alternative in FIG. 4A.

In an embodiment the flow is directed to only one or a portion of the separation surfaces or lamellae and the remaining separation surfaces or lamellae of the separation device are mechanically coupled to that hit by the flow, so that all lamellae also carry out the pivoting movement of the lamellae hit by the flow.

FIGS. 5A and 5B show in detail a lateral view (5A) and a top view (5B) of a control device for the separation device. The control device of FIG. 5A comprises a housing 35 in which a groove 34 is arranged as a guiding element for a ring-shaped flow body 33. The supplied solid-loaded liquid 38 is fed into the housing 35 of the control device by a supply opening 39. A longish guiding element 41 of the flow body 33 engages in the groove 34 so that a rotation of the flow body is avoided. The guiding element 41 of the flow body is connected to the connection element 36. By means of the liquid supply a force is exerted on the flow body 33 so that it can perform a maximum movement from its upper stopper (pos. 1) to its lower stopper (pos. 2). This movement is transferred to the separation surfaces 7 (lamellae) via a connection element 36 (compare 6 in FIG. 1A). Diverting elements 40 and 37 guide the connection element being a rope herein, which transfers the traction force for changing the lamella position with commencing flow, and which uses the gravity-conditional retraction of the lamellae into the cleaning position for retracting the flow body 33 with decreasing flow.

FIGS. 6A and 6B show a lateral view and a top view of a control device being similar to that of FIG. 5A, wherein a unilaterally supported plate 43 is provided as a flow body. The pivotable bearing of the plate is provided by a bolt 42 mounted in a bearing housing 52. By the arrangement of the guiding element 44 of the plate the upper (pos. 1) and lower (pos. 2) stopping position and thus the maximum movement within the guiding element 46 of the housing 45 is determined. By the movement of the plate 43 its alignment angle in the housing 45 changes and thereby the gap 53 for the solid-loaded liquid 49 flowing through. By this combination of the flow body 43 and the housing shape a specific control characteristic can be generated which may be individually adapted to any solid-loaded liquid to be treated.

FIG. 7 and FIG. 8 show the schematic assembly of a composite separation surface. In FIG. 7 the structured surface 55 used for the separation of the particles 57 existing in a stable suspension is fixedly connected to the smooth surface 56, at which the particles 58 of the instable suspension are deposited. The indicated flow thread or flow path 54 divides between the individual solid surfaces and the sedimentations on the smooth surface slip off as film 59 in the cleaning position (compare position in FIG. 1A).

A further alternative (FIG. 8) of the composite separation surfaces shows two functional surfaces removably connected to each other and/or arranged as spaced surfaces or plates. The active separation surface 63 is connected to the separation surface 62 for the particulate substances via fixing clips 65. Due to the special structure of the active separation surface only the particles 64 being solved and existing in a stable suspension (less than about 150 μm) can flow through this surface. During this process the solutes are accumulated at the active materials, such as activated charcoal, and thus the liquid is cleaned. The bigger particulate solids 66 are separated from the liquid at the smooth surface.

In a not shown embodiment of the described separation devices the first lamella, seen from the flow direction, is provided with at least one lever, the pivoting point of which is above the liquid level and which is connected to the control device or coupled to it, so that by the ratio of the lever arms around the pivoting point a smaller, an unchanged or a greater angle change of the lamellae in relation to the movement of the control element in the control device can be achieved.

In a further embodiment of the above arrangements at least one raised part is arranged on the individual lamellae, for example in form of knob or a support arm, on which the lamellae subordinated in flow direction can be supported, wherein the end of the raised part, on which the subsequent lamella lies, is formed so that during the adjustment the angle is approximately equal for all lamellae, so that by the adjustment of the first lamella in flow direction the entire lamella package can be adjusted.

FIGS. 9A-C schematically show three embodiment alternatives of a water treatment system 100 having a lamella separator in combination with a coarse substance separation device. The coarse substance separation device includes for example a rake as well as a separation stage for lipoid or lipid substances, for example a ventilated grease trap. The individual system stages can be provided in monolithic or integrated way or as separate stages and can be connected by flange connections. The alternatives in FIGS. 9A to 9C show three main application cases of the cleaning combinations 100, wherein all stages in turn can be multi-combined among each other. Equal or equally acting elements have the same reference numerals. The arrows show the flow direction of the liquid to be treated.

The liquid to be treated, for example municipal wastewater, is fed in the alternative of FIG. 9A via an inflow channel 101 to a rake system 102, in which coarse substances are deposited. This alternative is in particularly appropriate for the use in “normal” wastewater. Behind the rake system 102 the wastewater freed from coarse substances is transported via a connection channel 105 to a collection channel 107, in which a ventilated grease trap device 103 is arranged. By means of the ventilation the separation process of the lipophilic substances is supported, wherein the grease trap 103 can also be formed in an unventilated way. The upfloated grease within the grease trap 103 is removed from the water treatment system 100 via a grease discharge channel 104. The waste waster cleaned of grease in the collection channel 107 has to flow through a control device 106 of a separation module, wherein by a connection element 109 the lamellae of the module or the modules are changed in their alignment angles. The lamella separator modules can be formed according to one of the embodiments shown in FIGS. 1 to 8. In an embodiment one or more control devices 106 are assigned to one module, or several modules of lamella separators are controlled by one control device.

The separated particulate mineral components of the wastewater, such as sand, are collected in the lower part of the lamella separator module and are removed from the system 100 by a discharge device or a discharge element 110, for example a transport screw. The mechanically pre-cleaned wastewater overflows into the outflow channel 111 and leaves the compact system.

The alternative of FIG. 9B is particularly convenient for wastewater having a high lipid ratio. Here the grease trap 103 is the first treatment stage in flow direction due to the high rate of lipophilic substances. A further improvement of the separation of lipophilic substances can for example be achieved by a further grease trap (not shown) in flow direction after the coarse substance removal device 102.

The alternative shown in FIG. 9C can preferably be used for solid-rich liquids, e.g. having a high mineral rate, in which at first via the supply channel 101 a distribution of the wastewater onto the lamella separator(s) 108 is provided and subsequently the solid-free liquid is supplied via a collection channel 112 to the downstream treatment stages 102, 103.

The use of functional layers at the separation device is also then advantageous, when the separation surfaces of the above shown separation devices are not moved by means of the described control device. For example, if the separation surfaces are stationary or are changeable in their position or alignment by means of operation elements.

### REFERENCE NUMERALS

1 inflow
2 outflow channel
3 housing
4, 4a flow body
5 guiding element
6, 6a connection element
7 separation surface
8 holding bar/connection element
9, 9a separation device
10 diverting element
11 control device
12 basin
13 flowbody
14 first connection element
15 deflection device
17 holding bar
18 lamella
19 second connection element
22 bearing
23 cam disk
24 bearing
25 control device/separation surface segment
26 pivot bearing
27 inflow channel
28 distribution channel
29 liquid
30 flow path
31 surface partial section
32 pivotal point
33 flow body
34 groove
35 housing
36 connection element
37 diverting element
38 liquid
39 supply opening
40 diverting element
41 guiding element
42 bolt
43 plate
44 guiding element
45 housing
46 guiding element
52 bearing housing
53 gap
54 flow thread
55 surface
56 surface
57 particle
58 particle
59 film
62 separation surface
63 separation surface
64 particle
65 fixing clip
66 solids
100 water treatment system
101 supply channel
102 rake system
103 grease trap
104 grease discharge channel
105 connection channel
106 control device
107 collection channel
108 lamella
109 connection element
110 discharge element
111 outflow channel
112 collection channel

1. Apparatus for separating solids (57, 58; 64, 66) from a liquid (38, 49), comprising:
at least one reservoir or basin (12) for receiving solid-loaded liquid and having at least one inflow (1, 27, 101) and/or outflow (2, 111);
at least one separation device (9, 16, 25, 55, 56, 62, 63, 108) for the solids arranged in the reservoir or basin (12), wherein the separation device has at least one separation surface, which is at least adjustable between a separation position and a cleaning position; and
a control device (57, 58; 64, 66; 106) coupled or connected to the separation device (9, 16, 25, 55, 56, 62, 63, 108) and operable by the liquid supplied into the reservoir or the basin (12), by means of which the position of the at least one separation surface can be changed or varied.

2. Apparatus according to claim 1, wherein by means of the control device (57, 58; 64, 66; 106) the position of the at least one separation surface is changeable dependent on the flow velocity of the supplied liquid.

3. Apparatus according to claim 2, wherein by means of the control device (57, 58; 64, 66; 106) the flow of the supplied liquid can be transformed into a movement or change of the position of the at least one separation surface.

4. Apparatus according to claim 3, wherein the control device (57, 58; 64, 66; 106) comprises at least one flow guiding device (3, 35), in which at least one flow body (4, 13) is arranged and to be actuated by at least a portion of the supplied liquid, or to which at least one flow body is assigned and to be actuated by at least a portion of the supplied liquid.

5. Apparatus according to claim 4, wherein by means of at least one deflection or diverting device a deflection or rotation of the at least one flow body can be transformed into a change of the position of the at least one separation surface.

6. Apparatus according to claim 5, wherein the deflection or diverting device acting between the control device (57, 58; 64, 66; 106) and the separation device (9, 16, 25, 55, 56, 62, 63, 108) comprises at least one traction or shear transferring element (6, 8, 14, 36, 109), in particular a chain, a rope or a bar.

7. Apparatus according to claim 6, wherein the flow body (4, 13, 31, 33, 43) comprises at least one partial surface including through holes, in particular a plate having longitudinal through holes, on which solids from the liquid can deposit.

8. Apparatus according to claim 7, wherein a detection device for detecting the flow velocity and/or the solid content of the liquid is assigned to the control device (57, 58; 64, 66; 106) and the control device solely or additionally changes or varies the position of the at least one separation surface depending on the signal detected by the detection device.

9. Apparatus according to claim 8, wherein the detection device comprises a mechanical, electrical, optical, pneumatic or hydraulic sensor and/or the control device transforms a detected signal or value change into a position change of the separation surfaces in a mechanical, electrical, pneumatic or hydraulic way.

10. Apparatus according to claim 9, wherein the at least one separation surface comprises at least partially a surface coating and/or an at least partially structured surface.

11. A separation device (9, 16, 25, 55, 56, 62, 6, 108) for separating solids (57, 58; 64, 66) from a liquid (38, 49), wherein the separation device comprises at least one separation surface, characterized in that the at least one separation surface comprises a surface coating and/or an at least partially structured surface.

12. The device according to claim 11, wherein the separation device (9, 16, 25, 55, 56, 62, 63, 108) comprises a plurality of lamellae with at least one of the separation surfaces, respectively.

13. The device according to claim 12, wherein the surface coating comprises nanoparticles and/or a surface structure facilitating at least in the cleaning position an automatic cleaning.

14. The device according to claim 11, wherein the at least one separation surface comprises a composite material or consists of a composite material.

15. The device according to claim 14, wherein the composite material is inseparably or detachably composed and/or comprises at least two components.

16. The device according to claim 15, wherein a first component of the composite material comprises a smooth surface structure, is formed in particular of cold-rolled stainless steel or plastic, and/or a second component comprises a structured surface, in particular a geotextile surface.

17. The device according to claim 16, wherein the structured surface and/or the surface coating comprise(s) at least one chemically and/or biologically active material, wherein the active material is in particular formed as sheathing of the structured surface.

18. The device according to claim 17, wherein the at least one chemically and/or biologically active material comprises a biocide-acting substance, an anti-microbial substance, silver ions, activated charcoal, cation and/or anion exchangers.

19. The device according to claim 18, wherein the separation surface comprises an anti-adhesive coating, a nanoparticle coating and/or polytetrafluorethylene.

20. A separation assembly (100) for separating solids (57, 58; 64, 66) comprising an apparatus for separating solids (57, 58; 64, 66) from a liquid (38, 49), which includes at least one reservoir or basin (12) for receiving solid-loaded liquid and having at least one inflow (1, 27, 101) and/or outflow (2, 111), at least one separation device (9, 16, 25, 55, 56, 62, 63, 108) for the solids arranged in the reservoir or basin (12), wherein the separation device has at least one separation surface, which is at least adjustable between a separation position and a cleaning position, and a control device (57, 58; 64, 66; 106) coupled or connected to the separation device (9, 16, 25, 55, 56, 62, 63, 108) and operable by the liquid supplied into the reservoir or the basin (12), by means of which the position of the at least one separation surface can be changed or varied and a coarse substance separation device (102) and/or a grease separation device (103) or the device (9, 16, 25, 55, 56, 62, 63, 108) and a coarse substance separation device (102) and/or a grease separation device (103).

21. The separation assembly according to claim 20, wherein the coarse substance separation device (102) and/or the grease separation device (103) are upstream to the apparatus or device (9, 16, 25, 55, 56, 62, 63, 108).

22. The separation assembly according to claim 21, wherein apparatus or device (9, 16, 25, 55, 56, 62, 63, 108) and the coarse substance separation device (102) and/or the grease separation device (103) are formed as integrated separation module.

23. A method for separating solids (57, 58; 64, 66) from a liquid (38, 49) being stationary and/or flowing in a reservoir or a basin (12), wherein the reservoir or the basin (12) comprises at least one inflow and/or outflow opening as well as at least one separation device (9, 16, 25, 55, 56, 62, 63, 108) for solids, characterized in that the separation device (9, 16, 25, 55, 56, 62, 63, 108) or parts of the separation device are movable or adjustable by means of the flow of the liquid supplied into the reservoir or the basin (12).

24. The method according to claim 23, wherein the separation device (9, 16, 25, 55, 56, 62, 63, 108) comprises separation surfaces and the position and/or the alignment of at least one of the separation surfaces is changeable by means of the flow, wherein the separation surfaces are in particular arranged lamella-like.

25. The method according to claim 24, wherein the position and/or alignment is changeable by means of a control device (11, 106), which transforms the flow pressure of the supplied liquid into the movement and/or adjustment of the separation device (9, 16, 25, 55, 56, 62, 63, 108).

26. Apparatus according to claim 1, wherein the control device (57, 58; 64, 66; 106) comprises at least one flow guiding device (3, 35),
in which at least one flow body (4, 13) is arranged and to be actuated by at least a portion of the supplied liquid, or
to which at least one flow body is assigned and to be actuated by at least a portion of the supplied liquid.

27. Apparatus according to claim 4, wherein the flow body (4, 13, 31, 33, 43) comprises at least one partial surface including through holes, in particular a plate having longitudinal through holes, on which solids from the liquid can deposit.

28. Apparatus according to claim 10, wherein the separation device (9, 16, 25, 55, 56, 62, 63, 108) comprises a plurality of lamellae with at least one of the separation surfaces, respectively.

29. The device according to claim 11, wherein the surface coating comprises nanoparticles and/or a surface structure facilitating at least in the cleaning position an automatic cleaning.

30. Apparatus according to claim 10, wherein the at least one separation surface comprises a composite material or consists of a composite material.

31. The device according to claim 14, wherein a first component of the composite material comprises a smooth surface structure, is formed in particular of cold-rolled stainless steel or plastic, and/or a second component comprises a structured surface, in particular a geotextile surface.

32. Apparatus according to claim 10, wherein the structured surface and/or the surface coating comprise(s) at least one chemically and/or biologically active material, wherein the active material is in particularly formed as sheathing of the structured surface.

33. The device according to claim 11, wherein the structured surface and/or the surface coating comprise(s) at least one chemically and/or biologically active material, wherein the active material is in particularly formed as sheathing of the structured surface.

34. Apparatus according to claim 10, wherein the separation surface comprises an anti-adhesive coating, a nanoparticle coating and/or polytetrafluorethylene.

35. The device according to claim 11, wherein the separation surface comprises an anti-adhesive coating, a nanoparticle coating and/or polytetrafluorethylene.

36. The separation assembly according to claim 20, wherein the apparatus or device (9, 16, 25, 55, 56, 62, 63, 108) and the coarse substance separation device (102) and/or the grease separation device (103) are formed as integrated separation module.
